(19) United States
(12) Patent Application Publication
(10) Pub. No.: US 2003/0189957 A1
(43) Pub. Date: Oct. 9, 2003

(54) Transport stream demultiplexer and method of deleting memory traffic

(75) Inventors: Katsuya Misu, Kanagawa (JP); Masaya Kanazawa, Kanagawa (JP)

Correspondence Address: Paul-J. Esatto, Jr., Scully, Scott, Murphy & Presser, 400 Garden City Plaza, Garden City, NY, 11530, US

(73) Assignee: NEC Electronics Corporation, Kanagawa (JP)

(21) Appl. No.: 10/406,707

(22) Filed: Apr. 3, 2003

(30) Foreign Application Priority Data
Apr. 3, 2002 (JP) 2002-100700

(51) Int. Cl. H04J 3/04

(52) U.S. Cl. 370/536; 370/229

(57) ABSTRACT

A transport stream demultiplexer which receives transport stream packets and outputs data included the packets, has functions of judging whether a received transport stream packet is a null packet, and, if the received transport stream packet is a null packet, prohibiting writing data included in the received transport stream packet thereinto.

### BACKGROUND OF THE INVENTION

1. Field of the Invention

The invention relates to a transport stream demultiplexer available particularly for a digital television set, a method of deleting memory traffic, and a program for causing a computer to carry out the method.

2. Description of the Related Art

A transport stream demultiplexer generally receives data in a satellite digital television chip, and outputs data to an external device such as an external memory or a high speed data (HSD) defined in IEEE 1394, in dependence on data contents. Since a transport stream demultiplexer is used in various areas and by various broadcasting providers, it is required to be in accord with various transport stream packet formats and various systems for dealing with transport stream packet formats. Hence, a transport stream demultiplexer is presently usually formed as a software.

Such a software includes null packets defined as data unnecessary for keeping a bit rate in a certain range in order to guarantee real-time reproduction of condensed video or audio data. FIG. 1 shows a ratio of null packets among all of received transport stream packets.

With reference to FIG. 1, data No. 1 shows that the number of null packets is 50,117, the total number of packets is 147,058, and hence, a ratio of the null packets to all of the packets is 34.1%, data No. 2 shows that the number of null packets is 51,182, the total number of packets is 147,057, and hence, a ratio of the null packets to all of the packets is 34.8%, data No. 3 shows that the number of null packets is 49,216, the total number of packets is 147,047, and hence, a ratio of the null packets to all of the packets is 33.5%, data No. 4 shows that the number of null packets is 458,690, the total number of packets is 1,286,764, and hence, a ratio of the null packets to all of the packets is 35.6%, data No. 5 shows that the number of null packets is 196,331, the total number of packets is 551,469, and hence, a ratio of the null packets to all of the packets is 35.6%, and data No. 6 shows that the number of null packets is 52,360, the total number of packets is 147,057, and hence, a ratio of the null packets to all of the packets is 35.6%.

An average of the ratios of the null packets to all of the packets among data Nos. 1 to 6 is 34.9%. This figure shows that a ratio of null packets to transport packet data in a satellite digital television is about 35%.

That is, when all data is output in HSD, about 35% of read/write traffic of a local memory is used as data for null packets. Similarly, a transport stream data buffer defined as an area of a local memory in which transport stream packets are stored is occupied by null packets by about 35%.

Hereinbelow is explained a structure and an operation of a conventional transport stream demultiplexer with reference to FIGS. 2 to 4 wherein FIG. 2 is a block diagram of a conventional transport stream demultiplexer, FIG. 3 is a flow chart showing steps carried out by the conventional transport stream demultiplexer, and FIG. 4 illustrates a structure of a buffer of a transport stream packet administrated by a memory equipped in the conventional transport stream demultiplexer.

The conventional transport stream demultiplexer 100 illustrated in FIG. 2 is comprised of a host interface 101, a block 102 for receiving transport stream packets, a central processing unit 103, a descrambler 104 or a block for releasing transport stream packets from being scrambled, and a direct memory access controller 105, a local memory 106, and an internal bus 107 which electrically connects the host interface 101, the block 102, the central processing unit 103, the descrambler 104, the direct memory access controller 105 and the local memory 106 to one another.

The host interface 101 is electrically connected to an external host (not/ illustrated) through a host bus 110. The direct memory access controller 105 is electrically connected to a high speed data (HSD) through a bus 112, and further to an external memory i30 through a memory bus 111. Herein, the external memory 130 is comprised of a synchronous dynamic random access memory (SDRAM). The local memory 106 includes a buffer 106a for storing transport stream packets therein.

The transport stream packet receiving block 102 writes a transport stream packet into a buffer 410 (see FIG. 4), and thereafter, outputs an interruption signal to the central processing unit 103, in the step S11.

On receipt of the interruption signal transmitted from the transport stream packet receiving block 102, the central processing unit 103 processes the transport stream packet having been written into the buffer 410. When it is necessary to transmit the transport stream packet to HSD, the central processing unit 103 activates the direct memory access controller 105, and transmits a command to the direct memory access controller 105 to transmit the transport stream packet to HSD, in step S12.

In accordance with the command received from the central processing unit 103, the direct memory access controller 105 reads a transport stream packet 411 (see FIG. 4) out of the buffer 410, and then, outputs the thus read-out transport stream packet 411 to HSD.

After outputting the transport stream packet to HSD, the direct memory access controller 105 transmits an interruption signal indicative of completion of transmitting the transport stream packet to HSD, to the central processing unit 103, in step S13.

On receipt of the interruption signal transmitted from the direct memory access controller 105, the central processing unit 103 releases the buffer 410, in step S14.

The above-mentioned steps S11 to S14 are repeatedly carried out every time a transport stream packet is received.

The above-mentioned conventional transport stream demultiplexer 100 stores all of data into the local memory 106, and, if necessary, outputs a received transport stream packet to HSD or the external memory 130.

In data transmission in a digital television set, null packets are also transmitted in order to keep a data-transmission rate constant, though null packets include unnecessary data.

In theory, it is not necessary at all to transmit null packets to HSD or the external memory 130. However, it is necessary in some cases to output data to a HSD port at a timing at which data has been input into the transport stream demultiplexer 100. To this end, the transport stream packet receiving block 102 writes all of received transport stream packets into the local memory 106, and then, the direct memory access controller 105 reads the transport stream packets out of the local memory 106, and outputs the thus read-out transport stream packet to HSD.

As mentioned above, in the conventional transport stream demultiplexer 100, since all of the transport stream packets are written into the local memory 106 and read out of the local memory 106, traffic in the memory bus 111 would be increased, resulting in the conventional transport stream demultiplexer 100 is put into an unstable condition with respect to an operation.

It is assumed hereinbelow that the conventional transport stream demultiplexer 100 has an architecture in which the central processing unit 103 receives base clocks having a frequency of 108 MHz, the central processing unit 103 carries out one command every three base clocks (in other words, the central processing unit 103 occupies the memory bus 111 by 33% to fetch one base clock out of the three base clocks), and the central processing unit 103 occupies the memory bus 111 to carry out a command of making access to the local memory 106.

Assuming a worst case that a command to be carried out by the central processing unit 103 is to make access to the local memory 106, the central processing unit 103 occupies the memory bus 111 by about 66%, and thus, the other parts 101, 102, 104 and 105 can occupy the memory bus 111 by about 33%.

FIG. 5 shows an occupation rate in the case that an input stream has a bit rate of 100 Mbps.

As shown in FIG. 5, the transport stream packet receiving block 102 has a memory bus occupation rate of 10%, the direct memory access controller 105 has a memory bus occupation rate of 10% in transmitting packets to HSD, the direct memory access controller 105 has a memory bus occupation rate of 6.5% in transmitting packets to the external memory 130, and the central processing unit 103 has a memory bus occupation rate of 66%. A total of the memory bus occupation rates is 92.5%. Accordingly, the memory bus 111 has an available space by 7.5%.

However, the list in FIG. 5 does not include accesses made from the central processing unit 103 to the transport stream demultiplexer. The above-mentioned available space of 7.5% is occupied by such accesses, and accordingly, an actual memory bus occupation rate reaches about 100%. This results in an unstable operation of the transport stream demultiplexer 100.

Japanese Patent Application Publication No. 2000-261760 has suggested a data-reproducer including first means for selecting a desired packet among input stream signals in which a plurality of packets is multiplexed to one another in time division, second means for selecting packets other than the desired packet, and converting the thus selected packets into null packets, third means for counting the number of the null packets, fourth means for recording the desired packet and the counted number of the null packets thereinto and reproducing those out thereof, and fifth means for making null packet in the same number as the number of reproduced null packets.

Japanese Patent Application Publication No. 2001-308876 has suggested a packet transporter including a transmitter and a receiver. The transmitter includes a separator which extracts and removes non-valid packets, a counter which counts the number of the thus removed non-valid packets, and reset them when a next particular packet arrives, and a device for transmitting stream data including valid packets and non-valid packet data indicative of the number of the non-valid packets into a common path in an occurrence order. The receiver includes a non-valid packet insert through which the stream data passes, and into which non-valid packets in equivalence with the received non-valid data are inserted.

Japanese Patent Application Publication No. 2001-244984 has suggested a circuit for outputting a stream comprised of a plurality of packets to a memory, including means for removing null packets out of the stream, and outputting the stream to the memory.

Japanese Patent Application Publication No. 2000-187940 has suggested a data-reproducer including a transmitter and a receiver. The transmitter includes first means for scrapping packets, second means for counting the sequential number of scrapped packets, and third means for outputting the sequential number of valid packets and scrapped packets. The receiver makes non-valid packets in the same number as the sequential number of the scrapped packets, and multiplexes the non-valid packets with valid packets.

### SUMMARY OF THE INVENTION

In view of the above-mentioned problems in the conventional transport stream demultiplexer, it is an object of the present invention to provide a transport stream demultiplexer and a method of deleting memory traffic both of which can delete memory traffic caused by null packets.

In one aspect of the present invention, there is provided a transport stream demultiplexer which receives transport stream packets and outputs data included the packets, including a device for judging whether a received transport stream packet is a null packet, and, if the received transport stream packet is a null packet, prohibiting writing data included in the received transport stream packet thereinto.

The device may apply a flag to the received transport stream packet to indicate that the received transport stream packet is a null packet.

The transport stream demultiplexer may further include a device for outputting a header of the received transport stream packet and dummy data following the header when the received transport stream packet is judged as a null packet.

The transport stream demultiplexer in accordance with the present invention makes data-input record without null packet data, and reproduces null packets, based on the data-input record, when packet-data is transmitted to HSD. Thus, the transport stream demultiplexer in accordance with the present invention solves the problem of traffic caused by null packets, which was not solved in the conventional transport stream demultiplexer.

In general, null packets are included in received transport stream packets by 30% or greater, though dependent on a bit rate. Hence, by introducing no null packets into the transport stream demultiplexer and reproducing the null packets only when they are to be transmitted to HSD, it would be possible to reduce traffic in internal buses and further reduce memory resource.

As will be explained in detail in a later mentioned embodiment, the transport stream receiving block writes transport stream packets into the local memory. A software installed in the central processing unit filters the transport stream packets stored in the local memory, in accordance with a command transmitted from an external host through the host interface, and outputs the transport stream packets to HSD or an external memory. The scrambled transport stream packets are transmitted to the descrambler through the central processing unit, and then, descrambled in the descrambler.

In the transport stream demultiplexer in accordance with the present invention, the transport stream receiving block, the direct memory access block, and a software installed in the central processing unit cooperates with one another to thereby deal with null packets and non-null transport stream packets separately from each other, ensuring reduction in memory traffic.

In another aspect of the present invention, there is provided a method of deleting memory traffic in a transport stream demultiplexer which receives transport stream packets and outputs data included the packets, including the steps of (a) judging whether a received transport stream packet is a null packet; and (b) prohibiting writing data included in the received transport stream packet into the transport stream demultiplexer, if the received transport stream packet is a null packet.

The method may further include the step of adding a flag to the received transport stream packet to indicate that the received transport stream packet is a null packet.

The method may further include the step of outputting a header of the received transport stream packet and dummy data following the header, when the received transport stream packet is judged as a null packet.

In still another aspect of the present invention, there is provided a program for causing a computer to carry out the above-mentioned method.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 shows a ratio of null packets to all of received transport stream packets.

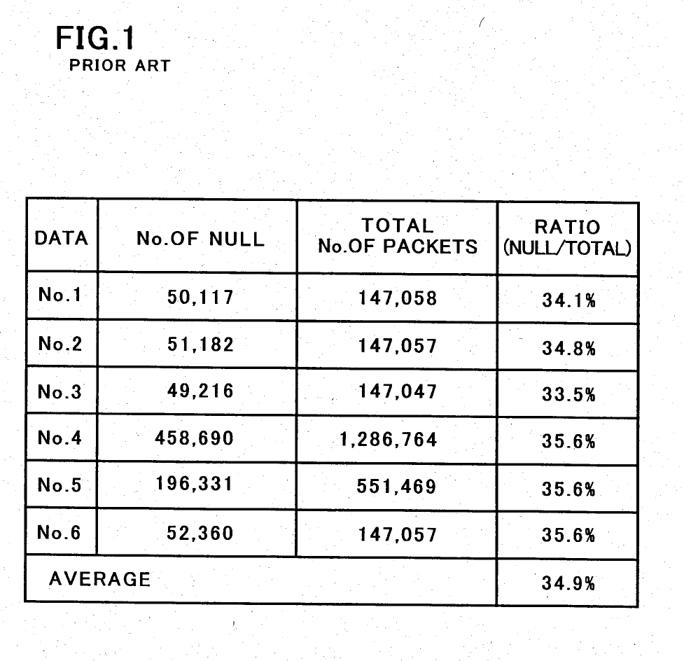

FIG. 2 is a block diagram of a conventional transport stream demultiplexer.

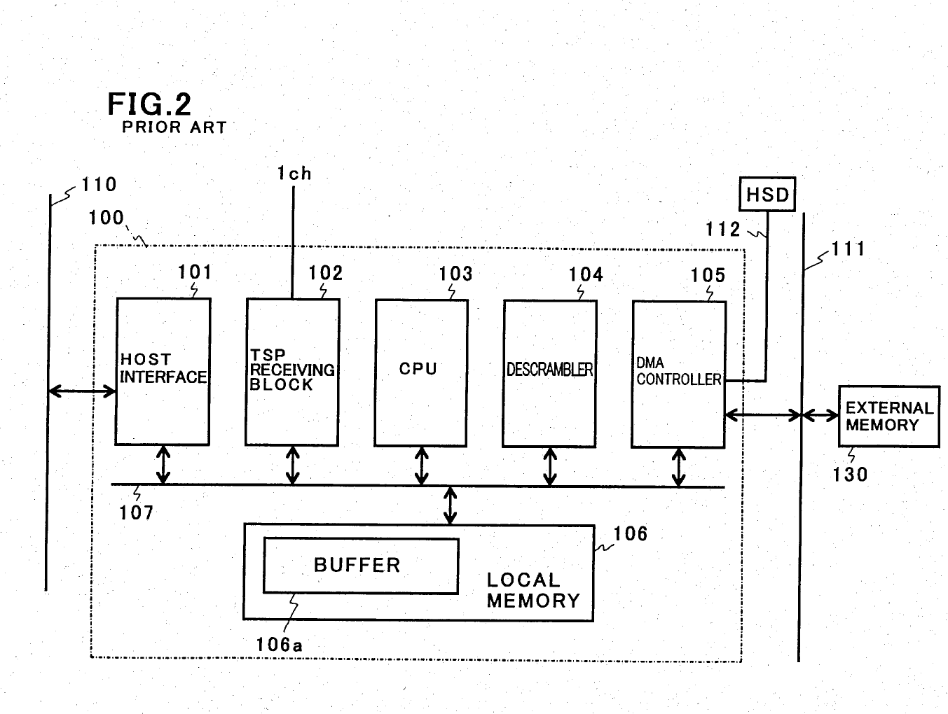

FIG. 3 is a flow chart showing steps carried out by the conventional transport stream demultiplexer illustrated in FIG. 2.

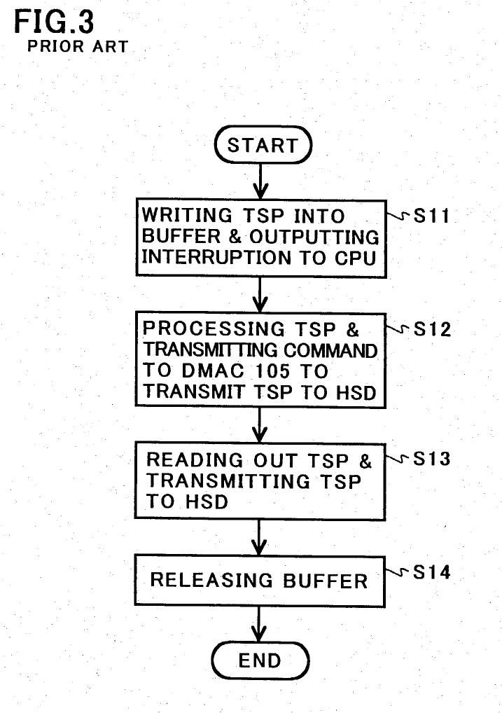

FIG. 4 illustrates a structure of a buffer of a transport stream packet administrated by a memory equipped in the conventional transport stream demultiplexer illustrated in FIG. 2.

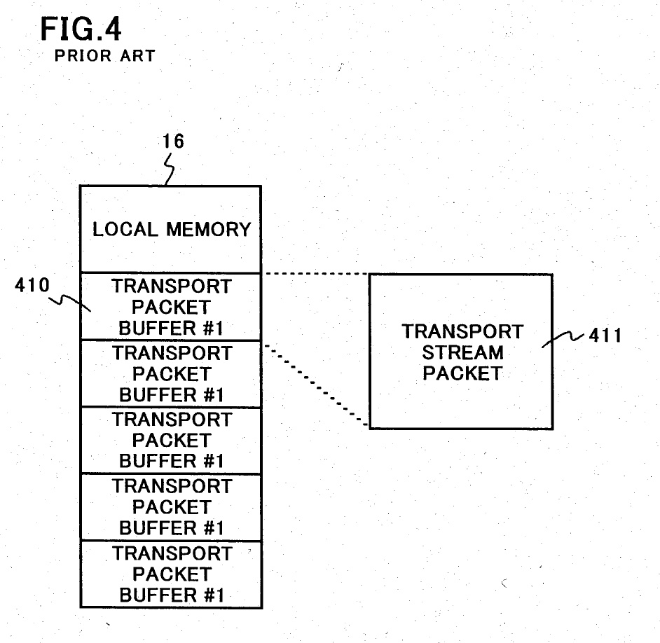

FIG. 5 shows a memory bus occupation rate in the conventional transport stream demultiplexer illustrated in FIG. 2 in the case that an input stream has a bit rate of 100 Mbps.

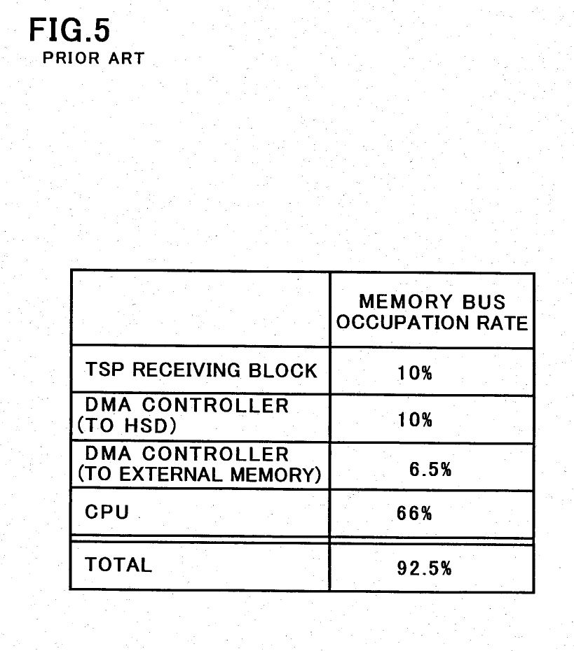

FIG. 6 is a block diagram of a transport stream demultiplexer in accordance with a preferred embodiment of the present invention.

FIG. 7 illustrates a structure of a buffer of a transport stream packet administrated by a memory equipped in the transport stream demultiplexer illustrated in FIG. 6.

FIG. 8 illustrates a structure of a transport stream packet to be processed by the transport stream demultiplexer illustrated in FIG. 6.

FIG. 9 is a flow chart showing steps carried out by the transport stream demultiplexer illustrated in FIG. 6.

FIG. 10 shows a memory bus occupation rate in the transport stream demultiplexer illustrated in FIG. 6.

### DESCRIPTION OF THE PREFERRED EMBODIMENTS

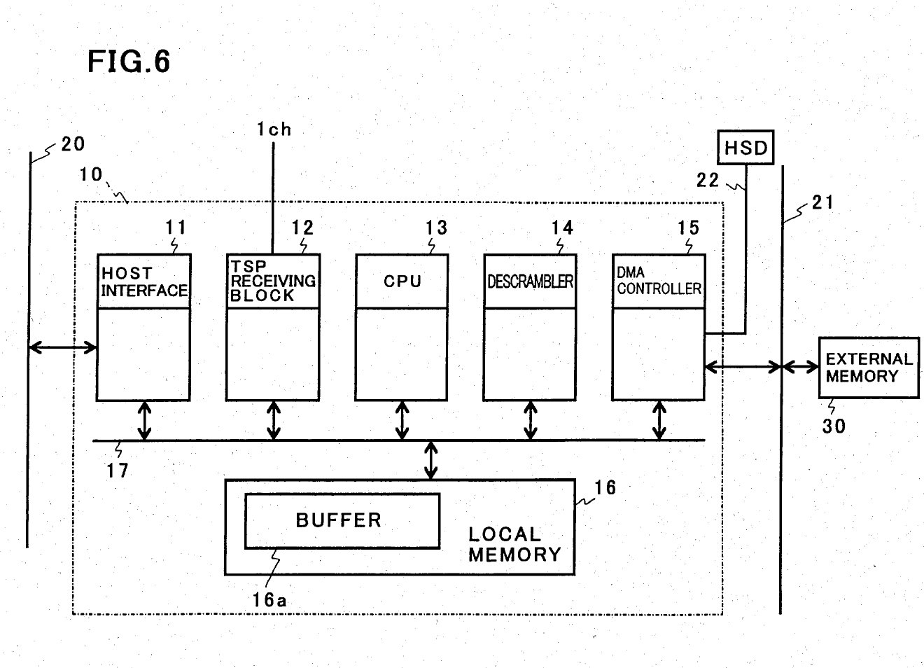

FIG. 6 is a block diagram of a transport stream demultiplexer 10 in accordance with the first embodiment of the present invention.

The transport stream demultiplexer 10 is comprised of a computer in the first embodiment. The transport stream demultiplexer 10 receives data in a satellite digital television chip, and outputs packets to an external memory or HSD in dependence on data contents.

The transport stream demultiplexer 10 is comprised of a host interface 11, a block 12 for receiving transport stream packets (TSPs), a central processing unit 13, a descrambler 14 or a block for releasing transport stream packets from being scrambled, and a direct memory access controller 15, a local memory 16, and an internal bus 17 which electrically connects the host interface 11, the block 12, the central processing unit 13, the descrambler 14, the direct memory access controller 105 and the local memory 16 to one another.

The host interface 11 is electrically connected to an external host (not illustrated) through a host bus 20. The direct memory access controller 15 is electrically connected to a high speed data (HSD) through a bus 22, and further to an external memory 30 through a memory bus 21. Herein, the external memory 30 is comprised of a synchronous dynamic random access memory (SDRAM). The local memory 16 includes a buffer 16a for storing transport stream packets therein.

A software for controlling an operation of the transport stream packet receiving block 12, the central processing unit 13, the descrambler 14 and the direct memory access controller 15 is stored in the local memory 16. For instance, the central processing unit 13 reads the software out of the local memory 16, and carries out the software to thereby operate the transport stream packet receiving block 12, the central processing unit 13, the descrambler 14 and the direct memory access controller 15.

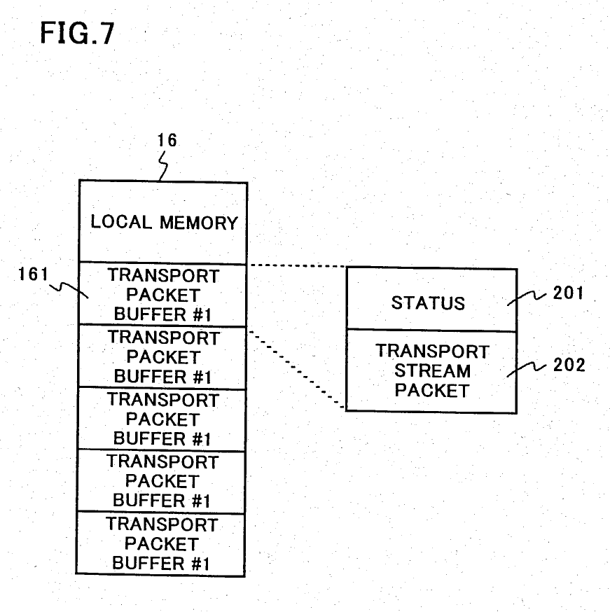

FIG. 7 illustrates a structure of a buffer of a transport stream packet administrated by the local memory 16.

As illustrated in FIG. 7, the local memory 16 is comprised of a plurality of transport stream buffers 161 each of which is comprised of status data 201 as a flag and a transport stream packet 202.

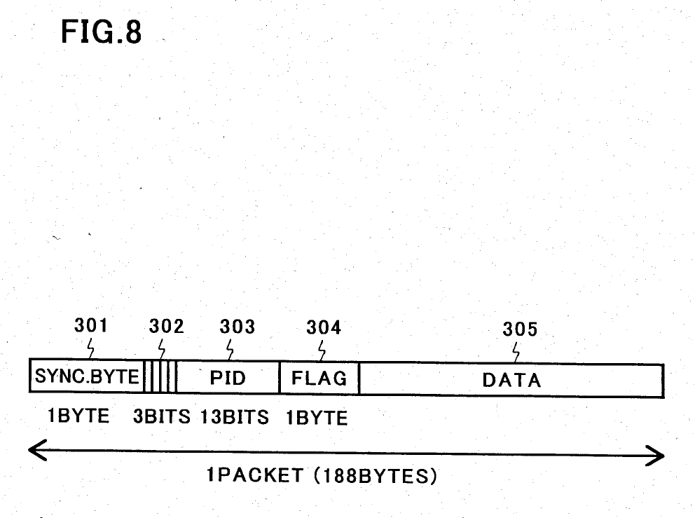

FIG. 8 illustrates a structure of a transport stream packet.

As illustrated in FIG. 8, a transport stream packet is comprised of a synchronization byte 301 having one byte, various flags 302 having three bits, a packet identifier (PID) 303 which identifies data to be transferred by a transport stream packet and which has thirteen bits, various flags 304 having one byte, and data 305 having 184 bytes. That is, a transport stream packet totally has 188 bytes.

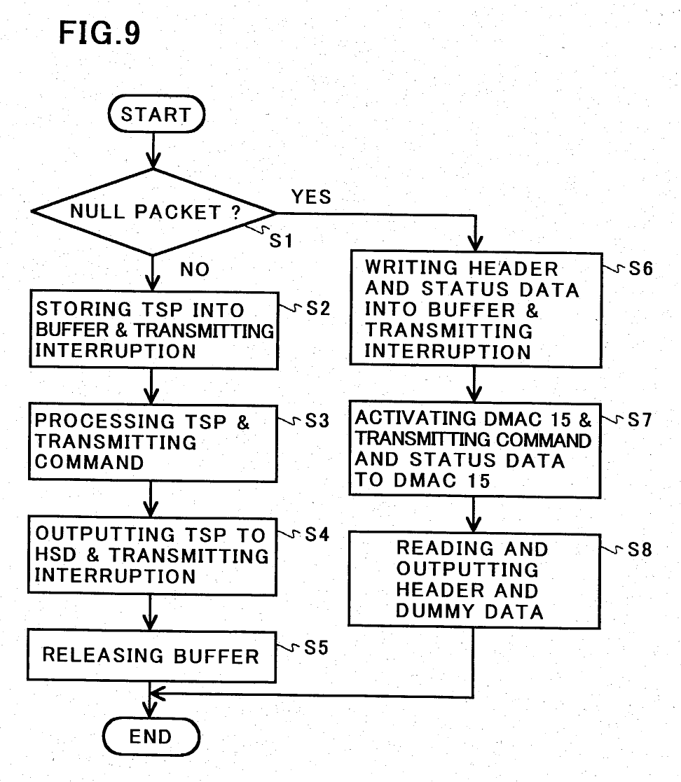

FIG. 9 is a flow chart showing steps carried out by the transport stream demultiplexer 10.

Hereinbelow is explained an operation of the transport stream demultiplexer 10 with reference to FIGS. 6 and 9. In the first embodiment, the present invention is applied to a transport stream packet format of the digital video broadcasting (DVB) type which is adopted mainly in Europe. The steps illustrated in FIG. 9 are carried out by the execution of the program stored in the local memory 16 by the central processing unit 13.

The transport stream receiving block 12 judges whether a received transport stream is a null packet or not in accordance with the packet identifier (PID) 303, in step S1. A transport stream packet received in the transport stream receiving block 12 is an ordinary or non-null packet, if the packet identifier (PID) 303 indicates “0x1fff”. Herein, a null packet is defined as an unnecessary packet transmitted only for keeping a transmission rate constant.

If the transport stream receiving block 12 judges that a received transport stream packet is an ordinary or non-null packet (NO in step S1), the transport stream receiving block 12 adds the status data 201 indicating that a received transport stream packet is an ordinary or non-null packet, to the received transport stream packet, and then, stores the received transport stream packet 202 into the buffer 161 of the local memory 16 together with the status data 201 as a flag.

After having stored the status data 201 and the transport stream packet 202 into the buffer 161, the transport stream receiving block 12 transmits an interruption signal to the central processing unit 13, in step S2.

On receipt of the interruption signal transmitted from the transport stream packet receiving block 12, the central processing unit 13 processes the transport stream packet 202 having been written into the buffer 161. When it is necessary to transmit the transport stream packet 202 to HSD, the central processing unit 13 activates the direct memory access controller 15, and transmits a command to transmit the transport stream packet 202 to HSD, to the direct memory access controller 15, in step S3.

In accordance with the command received from the central processing unit 13, the direct memory access controller 15 reads the transport stream packet 202 out of the buffer 161, and then, outputs the thus read-out the transport stream packet 202 to HSD.

After outputting the transport stream packet 202 to HSD, the direct memory access controller 15 transmits an interruption signal indicative of completion of transmission of the transport stream packet 202 to HSD, to the central processing unit 13, in step S4.

On receipt of the interruption signal transmitted from the direct memory access controller 15, the central processing unit 13 releases the buffer 161, in step S5.

If the transport stream packet receiving block 12 judges that a received transport stream packet is a null packet (YES in step S1), the transport stream packet receiving block 12 writes first four bytes 301 to 304 of the received transport stream packet 202 together with the status data 201 into the buffer 161 of the local memory 16.

After having written the first four bytes 301 to 304 as a header of the received transport stream packet 202 together with the status data 201 into the buffer 161, the transport stream receiving block 12 transmits an interruption signal to the central processing unit 13, in step S6.

On receipt of the interruption signal transmitted from the transport stream packet receiving block 12, the central processing unit 13 checks the status data 201 added to the received transport stream packet 202. If the central processing unit 13 judges that the received transport stream packet 202 is a null packet, when it is necessary to transmit the transport stream packet 202 to HSD, the central processing unit 13 activates the direct memory access controller 15, and transmits both a command to transmit the first four bytes 301 to 304 of the transport stream packet 202 to HSD, and the status data 202, to the direct memory access controller 15.

Then, the central processing unit 13 releases the buffer 161 from being in use, in step S7.

In accordance with the command received from the central processing unit 13, the direct memory access controller 15 reads the header or the first four bytes 301 to 304 of the transport stream packet 202 out of the buffer 161, and further reads the rest of the transport stream packet 202, that is, “0” in 184 bytes as dummy data out of the buffer 161. Then, the direct memory access controller 15 outputs the thus read-out header of the transport stream packet 202 and subsequent dummy data to HSD.

After having output the first four bytes 301 to 304 together with the status data 201 to the buffer 161, the direct memory access controller 15 transmits an interruption signal to the central processing unit 13, in step S8.

The transport stream demultiplexer 10 repeatedly carries out the above-mentioned steps each time the transport stream demultiplexer 10 receives a transport stream packet.

In accordance with the above-mentioned first embodiment, it is possible to reduce memory traffic caused by null packets included in all of received transport stream packets by about 35%, and hence, reduce memory access carried out by the transport stream packet receiving block 12 and the direct memory access controller 15, down to about 65%.

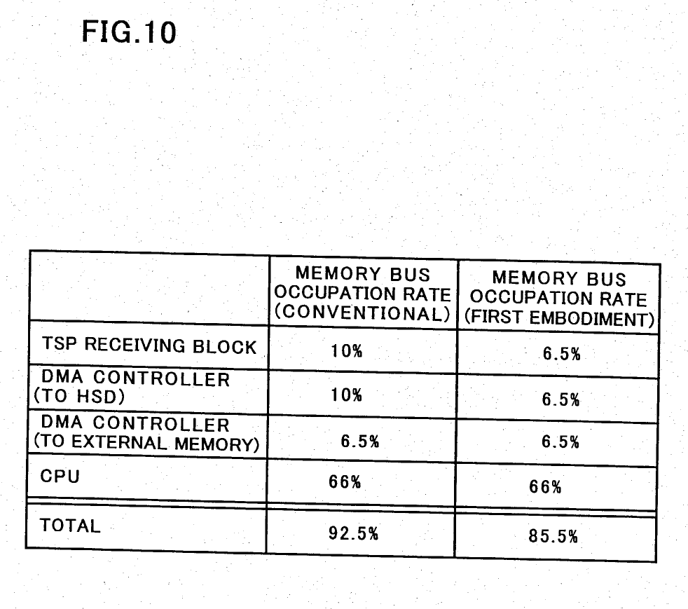

FIG. 10 shows a memory bus occupation rate in the transport stream demultiplexer 10.

With reference to FIG. 10, whereas a rate at which the transport stream packet receiving block 102 in the conventional transport stream demultiplexer 100 occupies the memory bus 111 in packet transmission is 10%, a rate at which the transport stream packet receiving block 12 in the transport stream demultiplexer 10 occupies the memory bus 21 in packet transmission is 6.5%. Similarly, whereas a rate at which the direct memory access controller 105 in the conventional transport stream demultiplexer 100 occupies the memory bus 111 in packet transmission to HSD is 10%, a rate at which the direct memory access controller 15 in the transport stream demultiplexer 10 occupies the memory bus 21 in packet transmission to HSD is 6.5%. A rate at which the direct memory access controller 105 in the conventional transport stream demultiplexer 100 occupies the memory bus 111 in packet transmission to the external memory 130 remains the same as a rate at which the direct memory access controller 15 in the transport stream demultiplexer 10 occupies the memory bus 21 in packet transmission to the external memory 30. Specifically, the rate remains at 6.5%. Similarly, a rate at which the central processing unit 103 in the conventional transport stream demultiplexer 100 occupies the memory bus 111 in packet transmission remains the same as a rate at which the central processing unit 13 in the transport stream demultiplexer 10 occupies the memory bus 21 in packet transmission. Specifically, the rate remains at 66%.

That is, whereas a total of the rates in the conventional transport stream demultiplexer 100 is 92.5%, a total of the rates in the transport stream demultiplexer 10 is 85.5%.

Thus, since the transport stream demultiplexer 10 in accordance with the first embodiment can reduce the above-mentioned rate down to 85.5% from 92.5%, a main central processing unit (not illustrated) can make access to the transport stream demultiplexer 10 through the memory bus 111.

In addition, since the transport stream demultiplexer 10 in accordance with the first embodiment early releases the buffer 161 in which null packets were stored, it would be possible to reduce memory resource.

Though the present invention is applied in the first embodiment to a transport stream packet format of the digital video broadcasting (DVB) type which is adopted mainly in Europe, the present invention can be applied to a transport stream packet format of Direc TV in the United States.

In the transport stream packet format of Direc TV, twelve bits in a header having 3 bytes have a field (SCID) corresponding to the packet identifier (PID) in the DVB system. When SCID is equal to zero, a packet having the SCID is a null packet. The transport stream packet format of Direc TV has data area having 130 bytes following the header, and hence, totally has 133 bytes.

If a received transport stream packet is a null packet, the header, that is, the first three bytes of the transport stream packet together with the status data is written into the local memory 16, in the above-mentioned step S6.

In the first embodiment, if a received transport stream packet is a null packet, only a header of the transport stream packet is stored into the local memory 16, and then, output to HSD. If a broadcasting provider writes particular data into data area in a null packet, the header together with the data area might be stored into the local memory 16, and then, output to HSD, in the above-mentioned steps S6 and S7.

The transport stream demultiplexer 10 has such a structure as mentioned above, and operates in such a manner as mentioned above.

The transport stream demultiplexer 10 may be accomplished by a data processor such as a personal computer or a work station, and a program to carry out the above-mentioned operation. Such a program may be presented through a recording medium readable by a computer. The program is read out into a data processor when the data processor starts its operation. By controlling an operation of the data processor, the parts constituting the transport stream demultiplexer 10, such as the host interface 11, the transport stream packet receiving block 12, the descrambler 14 and the direct memory access controller 15, can be accomplished in the data processor. The local memory 16 can be accomplished by a storage device of the data processor, such as a magnetic disc.

In the specification, the term “recording medium” means any medium which can record data therein.

The term “recording medium” includes, for instance, a disk-shaped recorder such as CD-ROM (Compact Disk-ROM) or PD, a magnetic tape, MO (Magneto Optical Disk), DVD-ROM (Digital Video Disk-Read Only Memory), DVD-RAM (Digital Video Disk-Random Access Memory), a floppy disk, a memory chip such as RAM (Random Access Memory) or ROM (Read Only Memory), EPROM (Erasable Programmable Read Only Memory), EEPROM (Electrically Erasable Programmable Read Only Memory), smart media (Registered Trade Mark), a flush memory, a rewritable card-type ROM such as a compact flush card, a hard disk, and any other suitable means for storing a program therein.

A recording medium storing a program for accomplishing the above-mentioned transport stream demultiplexer may be accomplished by programming functions of the above-mentioned transport stream demultiplexer with a programming language readable by a computer, and recording the program in a recording medium such as mentioned above.

A hard disc equipped in a server may be employed as a recording medium. It is also possible to accomplish the recording medium in accordance with the present invention by storing the above-mentioned computer program in such a recording medium as mentioned above, and reading the computer program by other computers through a network.

As a computer, there may be used a personal computer, a desk-top type computer, a note-book type computer, a mobile computer, a lap-top type computer, a pocket computer, a server computer, a client computer, a workstation, a host computer, a commercially available computer, and electronic exchanger, for instance.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2002-100700 filed on Apr. 3, 2002 including specification, claims, drawings and summary is incorporated herein by reference in its entirety.

What is claimed is:

1. A transport stream demultiplexer which receives transport stream packets and outputs data included said packets, comprising a device for judging whether a received transport stream packet is a null packet, and, if said received transport stream packet is a null packet, prohibiting writing data included in said received transport stream packet thereinto.

2. The transport stream demultiplexer as set forth in claim 1, wherein said device adds a flag to said received transport stream packet to indicate that said received transport stream packet is a null packet.

3. The transport stream demultiplexer as set forth in claim 1, further comprising a device for outputting a header of said received transport stream packet and dummy data following said header when said received transport stream packet is judged as a null packet.

4. A method of deleting memory traffic in a transport stream demultiplexer which receives transport stream packets and outputs data included said packets, comprising the steps of:
(a) judging whether a received transport stream packet is a null packet; and
(b) prohibiting writing data included in said received transport stream packet into said transport stream demultiplexer, if said received transport stream packet is a null packet.

5. The method as set forth in claim 4, further comprising the step of adding a flag to said received transport stream packet to indicate that said received transport stream packet is a null packet.

6. The method as set forth in claim 4, further comprising the step of outputting a header of said received transport stream packet and dummy data following said header, when said received transport stream packet is judged as a null packet.

7. A program for causing a computer to carry out a method of deleting memory traffic in a transport stream demultiplexer which receives transport stream packets and outputs data included said packets, said method comprising the steps of:
(a) judging whether a received transport stream packet is a null packet; and
(b) prohibiting writing data included in said received transport stream packet into said transport stream demultiplexer, if said received transport stream packet is a null packet.

8. The program as set forth in claim 7, wherein said method further includes the step of adding a flag to said received transport stream packet to indicate that said received transport stream packet is a null packet.

9. The program as set forth in claim 7, wherein said method further includes the step of outputting a header of said received transport stream packet and dummy data following said header, when said received transport stream packet is judged as a null packet.
